(19) United States
(12) Patent Application Publication
(10) Pub. No.: US 2025/0016752 A1
(43) Pub. Date: Jan. 9, 2025

(54) PARALLEL UPLINK TRANSMISSION BASED ON FREQUENCY-DOMAIN MULTIPLEXING INFORMATION

(71) Applicant: Nokia Technologies Oy, Espoo (FI)

(72) Inventors: Matha DEGHEL, Massy (FR); Keeth Saliya Jayasinghe LADDU, Espoo (FI)

(21) Appl. No.: 18/709,694

(22) PCT Filed: Nov. 22, 2021
(86) PCT No.: PCT/EP2021/082523

§ 371 Date: May 13, 2024

(51) Int. Cl. H04W 72/0453

(52) U.S. Cl. CPC H04W 72/0453

(57) ABSTRACT

There is inter alia disclosed a user equipment. UE, for transmitting at least two parallel uplink transmissions associated with a common uplink information payload and including a first uplink transmission and a second uplink transmission, comprising means for:—receiving information indicative of a common frequency-domain resource allocation for the at least two parallel uplink transmissions:—determining, a first frequency-domain resource allocation for the first uplink transmission and a second frequency-domain resource allocation for the second uplink transmission at least based on the common frequency-domain resource allocation and on frequency-domain multiplexing information indicative of a frequency gap or a frequency offset between the first frequency-domain resource allocation and the second frequency-domain resource allocation; and—transmitting the first uplink transmission using the first frequency-domain resource allocation and transmitting the second uplink transmission using the second frequency-domain resource allocation.

### TECHNOLOGICAL FIELD

The disclosure is generally related to communication networks, such as wireless radio networks comprising base stations and user equipments, communicating with each other, or mobile devices communicating with each other. More specifically, the disclosure is in particular applicable to a scenario of multiple transmission reception points (multi-TPR) with multiple transmissions or repetitions transmitted to such TPRs.

### BACKGROUND

The present disclosure is related but not limited to communication networks as defined by the 3GPP standard, such as the 5G standard, also referred to as New Radio, NR.

For a better understanding of the techniques and scenarios, on which the invention builds and in which the invention can advantageously be used, some technical aspects of NR, described in different releases of the standard, shall briefly be explained in the following.

PUSCH multi-antenna precoding modes are described in Rel-15 of NR. A UE can be configured in two different modes for PUSCH multi-antenna precoding, namely codebook-based transmission and non-codebook-based transmission. For codebook-based DG (dynamic grant) PUSCH, the UE determines SRI (SRS resource indicator) and TPMI (Transmit Precoding-Matrix Indicator) information (via Precoding information and number of layers) from the corresponding fields in DCI. The SRI basically provides the UL beam information, and TPMI provides UL precoder information. For non-codebook-based DG PUSCH, in contrast to codebook-based mode, the UE determines its precoder and transmission rank based on downlink measurements. However, the UE selection of a precoder (and the number of layers) for each scheduled PUSCH may be modified by the network (in case multiple SRS resources are configured), basically by omitting some columns from the precoder that the UE has selected. This latter step is done by indicating, via SRI contained in DCI scheduling the PUSCH, a subset of the configured SRS resources.

Furthermore, the modulation and coding scheme (MCS) for PUSCH is determined from the MCS field indicated via DCI (at least for dynamically scheduled PUSCH), considering a (regular) MCS table (where the considered table depends on whether 256QAM is not configured or not). Some of the combinations/entries of the MCS field are reserved and used for retransmissions purpose only. An alternative MCS table providing lower spectral efficiency values may be configured-mainly targeting a higher reliability. Whether to use the regular table or the more robust table is indicated by the RNTI scheduling the UE, i.e. the C-RNTI implies that the regular table should be used and the MCS-C-RNTI implies that the more robust table should be used.

The time-domain resource allocation/assignment for a scheduled transport block (TB) on PUSCH is provided via a DCI field. Specifically, this field provides a row index to a table (TDRA table), where a row defines the slot offset, the start and length indicator (SLIV), and the mapping type (type A or type B).

The frequency-domain resource allocation/assignment for a scheduled transport block (TB) on PUSCH is also provided via a DCI field. Two types of frequency domain allocation: type 0) and type 1. For type 0, a bitmap of Resource Blocks (RB) is signaled in DCI (the size of the bitmap would be equal to the number of resource blocks in the BWP). To reduce the bitmap size while maintaining the allocation flexibility, a group of contiguous resource blocks as opposed to individual RBs could be used: the size of the resource block group (RBG) is determined by the size of the BWP. For type 1, starting RB and number of RBs are signaled in DCI-thus only allowing contiguous allocations in frequency domain.

In Rel-15, a so called PUSCH repetition Type A via slot aggregation was supported in a semi-static way. i.e. no repetition within a slot, with aggregation factor of 2, 4 or 8. This repetition operation is also referred to as slot-based repetition.

A PUSCH repetition Type B was introduced in Rel-16 NR. The motivations for PUSCH enhancements in Rel-16 were to allow one allocation cross-slot-boundary and cross-DL-symbols scheduling for reduced latency without sacrificing reliability (a.k.a. multi-segment transmission in Rel-16 IIOT Study Item phase). The related Rel-16 objective were a specification of PUSCH enhancements for both dynamic-grant based PUSCH and configured-grant based PUSCH. For a transport block, one dynamic UL grant or one configured grant schedules two or more PUSCH repetitions that can be in one slot, or across slot boundary in consecutive available slots.

One nominal repetition can be segmented into one or more actual repetitions around semi-static DL symbols and dynamically indicated/semi-statically configured invalid UL symbols and/or at the slot boundary. For dynamic grant, the actual repetitions are transmitted. There should not be conflict between the transmitted symbols and the dynamic DL/flexible symbols (indicated by dynamic SFI). For configured grant, whether the actual repetition is transmitted or not follows Rel-15 principle. It is not transmitted if it conflicts with any dynamic DL/flexible symbols: it is not transmitted if it conflicts with any semi-static flexible symbol if dynamic SFI is configured but not received.

The time-domain resource allocation is defined by S (starting symbol). L (length of each nominal repetition) and K (number of nominal repetitions), which are signaled as part of the TDRA entry. The TDRA field in DCI indicates one of the entries in the TDRA table. S: 0 to 13. L: 1 to 14. K is {1, 2, 3, 4, 7, 8, 12, 16}. The maximum number of entries in the TDRA table was increased to 64.

As before, in NR, the PUCCH (Physical Uplink Control Channel) is used to carry UCI (Uplink Control Information) such as SR (scheduling request), which could also be used or dedicated for BFR (Beam Failure Recovery) request or LRR (link failure recovery request), HARQ-ACK (Hybrid automatic repeat request acknowledgement), and CSI (Channel State Information). The PUCCH Format 2, 3 and 4 could carry HARQ-ACK, SR (which may be used for BFR or LRR), and/or CSI, whereas Format 0 and 1 can only carry SR and/or up to two HARQ-ACK bits. Each format has a Format configuration in the PUCCH configuration. The PUCCH configuration defined in TS 38.331 contains the different parameters related to PUCCH. In this configuration, the UE could be configured with a number of PUCCH resources.

A PUCCH resource consists essentially of the following parameters (TS 38.331):
a PUCCH resource index, used to identify the PUCCH resource,
a configuration for a PUCCH format, which contains e.g. the number of OFDM symbols and the number of PRBs (and, for formats 1 and 4, OCC (orthogonal cover code) related parameters), the maxCodeRate, number of PRBs (nrofPRBs) which represents the maximum number of PRBs (at least for formats 2 and 3),
an index of the first PRB prior to frequency hopping or for no frequency hopping.
an index of the first PRB after frequency hopping (if any).

In Rel-15, a UE can be configured up to four sets of PUCCH resources, where each PUCCH resource set corresponds to a certain range of UCI (uplink control information) load (TS 38.213). PUCCH resource set 0 can handle UCI payloads up to two bits and thus may only contain PUCCH formats 0 and 1, whereas the other PUCCH resource sets may contain any PUCCH format except format 0 and 1.

Furthermore, Rel-16 NR introduced some enhancements for the PUCCH formats mainly for unlicensed operation: these enhancements are known as interlaced (PUCCH) transmission. Related parameters and details can be found in TS 38.213 and TS 38.331.

The PUCCH determination mainly depends on at least one of: PRI (PUCCH resource indicator) in DCI, UCI payload size, first CCE index of the PDCCH carrying the DCI, the total number of CCEs in the CORESET on which the PDCCH carrying the DCI has been transmitted, UCI configuration (such as SR configuration, CSI configuration, SPS HARQ-ACK configuration). The detailed procedure for PUCCH resource determination can be found in TS 38.213, Section 9.

Specifically, when the UE needs to send UCI (including at least HARQ-ACK), the PUCCH resource set is determined based on the UCI load, and the PUCCH resource within this set is determined using the PRI (PUCCH resource indicator) in the DCI (downlink control information). On the other hand, the PUCCH resources for SR (scheduling request) and P-CSI (periodic CSI) are semi-statically (RRC) configured, where the resources are given in the SR and CSI configurations (see TS 38.331).

Rel-15 NR defined the PUCCH repetition operation on multiple slots for PUCCH formats 1, 3 and 4, where the main objective of PUCCH repetition is to increase reliability and coverage for the transmitted UCI. For each of these formats, the repetition operation, if enabled, consists in repeating the PUCCH carrying UCI (uplink control information) over multiple consecutive slots. Specifically, for PUCCH formats 1, 3, or 4, a UE could be configured via RRC with a number of slots for repetitions of a PUCCH transmission, where this number is denoted in the specifications by N_{PUCCH}^{repeat} or sometimes by nrofSlots. The PUCCH repetition operation could be essentially described as follows (TS 38.213):
the UE should repeat the PUCCH transmission carrying the UCI over the preconfigured number of slots repeat for repetition (i.e. over N_{PUCCH}^{repeat} slots),
the PUCCH repetition/transmission in each of the slots has at least a same number of consecutive symbols and a same number of PRBs,
the PUCCH repetition/transmission in each of the slots has a same first symbol,
the UE is configured whether (or not) to perform frequency hopping for PUCCH repetitions/transmissions in different slots.

In Rel-17 NR, enhancements on the support for multi-TRP deployment were studied. The list of objectives regarding the multi-TRP operation work is described in RP-193133, where one of the key objectives is to identify and specify features to improve reliability and robustness for channels other than PDSCH (that is, PDCCH, PUSCH, and PUCCH) using multi-TRP and/or multi-panel, with Rel. 16 reliability features as the baseline.

Considering the Rel-17 discussions, a multi-TRP PUCCH scheme could be any of the following: multi-TRP inter-slot PUCCH repetition (known as scheme 1), multi-TRP intra-slot PUCCH repetition (known as scheme 3), multi-TRP PUCCH intra-slot beam hopping (known as scheme 2).

In addition, the support of a single PUCCH resource has been agreed. This implies that a single PUCCH resource will be used for the different (TDM-ed) repetitions towards different TRPs. And up to two spatial relation infos would be indicated/activated for a PUCCH resource via MAC CE, at least in FR2. And up to two sets of power control parameters would be indicated/activated for a PUCCH resource via MAC CE, at least in FR1—where a set may contain p0, pathloss RS ID, and a closed-loop index.

The PUCCH repetition factor (i.e. number of PUCCH repetitions) may be dynamically indicated (e.g. via DCI) or configured via RRC. One approach for somewhat dynamic indication, recently agreed under Coverage enhancements WI as a working assumption, is that a PUCCH resource can be associated (via RRC) with a PUCCH repetition factor. Thus, PRI (indicated via DCI) can be used to select a PUCCH resource associated with the required PUCCH repetition factor.

On the other side, for the multi-TRP PUSCH enhancements, M-TRP TDMed PUSCH repetition scheme based on Rel-16 PUSCH repetition Type A and Type B was agreed, where two beams/SRIs are indicated via DCI. Also, the same number of layers per TRP is supported. Specifically, for codebook-based PUSCH, the UE is provided with two SRIs and two TPMIs (second field does not indicate number of layers) for PUSCH repetition operation. And for non-codebook-based PUSCH, the UE is provided with two SRIs (second field does not indicate number of layers) for PUSCH repetition operation.

In view of the above, there remains the problem of improving the multiplexing scheme(s) of the prior art.

### SUMMARY OF SOME EXEMPLARY EMBODIMENTS

Certain embodiments of the invention may have the effect of enabling sufficiently flexible multiplexing scheme(s) from a frequency domain allocation perspective. Also, certain embodiments may have the effect of enabling a dynamic switching between different multiplexing (such as SDM, FDM and TDM) schemes. More specifically, certain embodiments of the present disclosure may have the effect of
provide sufficient flexibility in the frequency domain allocation when considering multi-TRP FDMed and SDMed UL transmission/repetition operations. At least for PUCCH, this allows increasing the UE multiplexing capacity.
allow to combat interference when such is needed.
dynamically choose and switch between multi-TRP FDM and SDM schemes.

According to an exemplary aspect, a user equipment, UE, for transmitting at least two parallel uplink transmissions associated with a common uplink information payload and including a first uplink transmission and a second uplink transmission is disclosed, the UE comprising means for:
receiving information indicative of a common frequency-domain resource allocation for the at least two parallel uplink transmissions;
determining a first frequency-domain resource allocation for the first uplink transmission and a second frequency-domain resource allocation for the second uplink transmission at least based on the common frequency-domain resource allocation and on frequency-domain multiplexing information indicative of a frequency gap or a frequency offset between the first frequency-domain resource allocation and the second frequency-domain resource allocation; and
transmitting the first uplink transmission using the first frequency-domain resource allocation and transmitting the second uplink transmission using the second frequency-domain resource allocation.

According to an exemplary aspect, a method performed by a user equipment. UE, for enabling at least two parallel UL transmissions associated with a common uplink information payload and including a first uplink transmission and a second uplink transmission is also disclosed, the method comprising:
receiving information indicative of a common frequency-domain resource allocation for the at least two parallel uplink transmissions;
determining a first frequency-domain resource allocation for the first uplink transmission and a second frequency-domain resource allocation for the second uplink transmission at least based on the common frequency-domain resource allocation and frequency-domain multiplexing information indicative of a frequency gap or frequency offset between the first frequency-domain resource allocation and the second frequency-domain resource allocation; and
transmitting the first uplink transmission using the first frequency-domain resource allocation and transmitting the second uplink transmission using the second frequency-domain resource allocation.

According to an exemplary aspect, a base station or a component thereof for receiving at least two parallel uplink transmissions associated with a common uplink information payload and including a first uplink transmission and a second uplink transmission is also disclosed, comprising means for:
transmitting information indicative of a common frequency-domain resource allocation for the at least two parallel uplink transmissions; and
receiving the first uplink transmission using a first frequency-domain resource allocation and receiving the second uplink transmission using a second frequency-domain resource allocation, the first frequency-domain resource allocation for the first uplink transmission and the second frequency-domain resource allocation for the second uplink transmission having been determined at least based on the common frequency-domain resource allocation and on frequency-domain multiplexing information indicative of a frequency gap or a frequency offset between the first frequency-domain resource allocation and the second frequency-domain resource allocation.

According to an exemplary aspect, a corresponding method, performed by a base station or a part thereof, is also disclosed.
According to a further exemplary aspect, a system comprising a user equipment according to the above aspect and a base station or part thereof according to the above aspect working together for performing the disclosed aspects is also disclosed.

The user equipment may be stationary device or a mobile device. The user equipment may in particular be a mobile device, such as a smart phone, a tablet, a wearable, a smartwatch, a low power device, an IoT device or the like. The user equipment is in particular capable of multi-TRP operation. Generally, the user equipment may also be any other device enabled for communication with a respective communication network, such as a vehicle, for instance a car. A user equipment or mobile station may be understood as any device used to communicate with a respective network. The user equipment of the first exemplary aspect may be in direct or indirect communication with a base station of the communication network or another user equipment.

A base station may be understood as a wireless communication station installed at a fixed or mobile location and may in particular be or comprise an entity of the radio access network or the core network of the communication system. The base station is in particular capable of multi-TRP operation. For instance, the base station may be or comprise a base station of a communication network of any generation (e.g. a gNB, eNodeB. BTS or the like). Generally, the base station may be or comprise a hardware or software component implementing a certain functionality. In an example, the base station may be an entity as defined by the 3GPP 5G standard (also referred to as gNB). Accordingly, while the base station may be understood to be implemented in or be a single device or module, the base station may also be implemented across or comprise multiple devices or modules. As such, the base station may in particular be implemented in or be a stationary device. Multiple base stations of the exemplary aspect may in particular establish a communication system or network, which may in particular be a New Radio (NR) or 5G system or any other mobile communications system defined by a past or future standards, in particular successors of the present 3GPP standards. The network entity of the second exemplary aspect may be in direct or indirect communication with the exemplary user equipment.

In general, the means of any of the disclosed apparatuses (i.e. user equipment and base station) can be implemented in hardware and/or software. They may comprise one or multiple modules or units providing the respective functionality. They may for instance comprise at least one processor for executing computer program code for performing the required functions, at least one memory storing the program code, or both. Alternatively, they could comprise for instance circuitry that is designed to implement the required functions, for instance implemented in a chipset or a chip, like an integrated circuit. In general, the means may comprise for instance one or more processing means or processors.

Thus, according to the respective exemplary aspects of the present disclosure, there is in each case also disclosed a respective apparatus (i.e. a base station and a user equipment) comprising at least one processor and at least one memory including computer program code, the at least one memory and the computer program code configured to, with the at least one processor, cause an apparatus at least to perform and/or to control the described exemplary aspect of the present disclosure.

Any of the above-disclosed exemplary aspects may, however, in general be performed by an apparatus, which may be a module or a component for a device, for example a chip. The disclosed apparatus may comprise the disclosed components, for instance means, processor, memory, or may further comprise one or more additional components.

According to the exemplary aspects of the present disclosure, there is in each case also disclosed a computer program, the computer program when executed by a processor of an apparatus causing said apparatus to perform a method according to the respective aspect.

The computer program may be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory, for instance a Read-Only Memory (ROM) or hard disk of a computer, or be intended for distribution of the program, like an optical disc.

In the following, further exemplary features and exemplary embodiments of the different aspects of the present disclosure will be described in more detail.

It should be noted that, in the present description, an (UL) beam may also refer to spatial relation info. (separate) UL TCI state, joint or common TCI state, spatial filter, power control info (or power control parameters set), panel or panel ID, etc. More generally, all these terms may be interchangeably used in this invention. It should further be noted that a TRP may be identified by at least one of the following: an SRS resource set, a BFD-RS (beam failure detection reference signal) set, a subset/set of UL beams, a CORESETPoolIndex (if configured), a PCI (physical cell ID). It should be further noted that a UE panel may be identified by a panel ID. Alternatively. or additionally, a panel may be identified or associated by at least one DL RS (or more generally RS) or simply by an UL beam.

As described in the above aspects, the at least two parallel uplink (UL) transmissions are associated with a common uplink information payload. Accordingly, the at least two uplink transmissions may comprise the same information or payload. In one embodiment, a single codeword or set of UCI bits is mapped across the first frequency-domain resource allocation and the second frequency-domain resource allocation.

However, in an example, this may not necessarily be the case and in an example, the at least two uplink transmissions may be associated with or comprise different information or payload. Accordingly, in an embodiment, a different codeword or UCI bits may be mapped to each of the first frequency-domain resource allocation and the second frequency-domain resource allocation.

Parallel UL transmissions may in particular be understood as transmissions at least partly or completely overlapping in time. Parallel UL transmissions may be in the same serving cells or bandwidth part (or in different serving cells or bandwidth part). E.g., in case when a supplementary uplink (SUL) is configured, the parallel UL transmissions may be in the same carrier or in different carriers (in the same cell). The parallel UL transmissions may be in the same cell or in cells having different physical cell ID.

The frequency-domain multiplexing information is indicative of a frequency gap or a frequency offset between the first frequency-domain resource allocation and the second frequency-domain resource allocation. In other words, frequency-domain multiplexing information may also be understood as frequency-domain separation information, as it can indicate a frequency-domain separation (which may also be understood as a frequency-domain multiplexing distance) between the first frequency-domain resource allocation and the second frequency-domain resource allocation.

That the frequency gap or offset is between the first frequency-domain resource allocation and the second frequency-domain resource allocation may be understood to mean that the frequency gap or offset is applied between the first frequency-domain resource allocation and the second frequency-domain resource allocation.

The frequency-domain multiplexing information may thus generally describe the distance, separation, shift or offset between the first and second frequency-domain resource allocation.

In exemplary embodiments, the frequency gap or offset information may indicate a positive frequency gap or offset. i.e. frequency gap or offset defining a distance between the two frequency-domain resource allocations in the frequency domain, so that they are non-overlapping. In exemplary embodiments, the frequency gap or offset information may indicate that no frequency gap or offset shall be used (e.g. the two frequency-domain resource allocations may be directly adjacent to each other). In exemplary embodiments, the frequency gap or offset information may indicate (e.g. by means of (a) negative value(s) or a specific value(s)) that there is a partial or even complete overlap between the two frequency-domain resource allocations in the frequency domain. For instance a frequency gap or offset information in the form of a gap value of −1 (or 0) may indicate that the two frequency-domain resource allocations are completely overlapping. i.e. the uplink transmission are sent with identical frequency-domain resources (but with different spatial relations e.g. towards different TRPs).

In an example, the first and second frequency-domain resource allocation is located within the common frequency-domain resource allocation. Due to the frequency gap or offset, there may be the case that the configured or indicated frequency gap or offset would require a frequency span greater than indicated by the common frequency-domain resource allocation (such as a BWP size). Accordingly, the UE may generally also apply a shorter or smaller frequency gap or offset than configured or indicated, in particular in case the configured or indicated gap would require frequency span greater than indicated e.g. by the BWP size.

In case the frequency gap or offset leads to unused resources in the frequency gap, the base station (e.g. gNB) may generally decide to either leave these resources unused or to allocate them to e.g. another UE(s).

In an example, the first and second uplink transmissions may thus be transmitted having the frequency gap or the frequency offset indicated by the frequency-domain multiplexing information. However, it may also be the case that the first and second uplink transmissions may be transmitted having a frequency gap or offset different (e.g. smaller) than indicated, which may be the case if the available bandwidth (e.g. the bandwidth part. BWP) does not allow for the indicated gap or offset. As there should be a common understanding between the UE and the base station which frequency allocations are used, in case the UE deviates from the indicated frequency gap or offset, the UE may use predefined rules for this and/or may signal such a deviation to the base station.

As will be explained in more detail in the following, the two uplink transmissions may in particular be uplink repetitions. Particularly, preferred embodiments may thus be a multi-TRP FDM PUCCH/PUSCH transmission (in particular repetition) scheme or a multi-TRP SDM PUCCH/PUSCH transmission (in particular repetition) scheme.

Under the multi-TRP context, in addition to the TDM (time domain multiplexing) PUCCH/PUSCH transmission (and in particular repetition) operations, the following operations/schemes are particularly relevant for PUCCH and PUSCH operation:
FDM (frequency domain multiplexing) PUCCH/PUSCH transmission operation, for which the same UCI/TB may be repeated at the same time (or at overlapping time domain resources) but on non-overlapping frequency domain allocations, where each repetition is transmitted towards a different TRP. Alternatively, instead of repeating the same TB/UCI, different parts of PUCCH/PUSCH (where a part may be a time allocation, a frequency allocation, layer(s), and/or coded bits) may be transmitted towards different TRPs.
SDM (spatial domain multiplexing) PUCCH/PUSCH transmission operation, for which the same UCI/TB may be repeated at the same time and frequency domain allocations (or at least at overlapping time and frequency resources), where each transmission may be transmitted towards a different TRP. Alternatively, instead of repeating the same TB/UCI, different parts of PUCCH/PUSCH (where a part may be a time allocation, a frequency allocation, layer(s), and/or coded bits) may be transmitted towards different TRPs.

The described approach basically realizes parallel uplink transmissions utilizing a dynamic indicating of a frequency gap or offset and thus provides an improved flexibility in the frequency domain allocation in particular when considering multi-TRP multiplexed (e.g. FDMed and SDMed) UL transmission and in particular repetition operations, which allows for increasing the UE multiplexing capacity. The approach in particular allows to combat interference with the frequency gap or offset when such is needed. Thus, as will be explained in more detail below, the described approach allows for multi-TRP enhancements essentially allowing simultaneous or parallel uplink transmissions (such as PUCCH/PUSCH and PUSCH/PUCCH/SRS/PRACH transmissions from two UE panels).

The frequency-domain multiplexing information may be determined based on received downlink control information. DCI, scheduling the at least two parallel uplink transmissions. The frequency-domain multiplexing information may be comprised in the received downlink control information. DCI, scheduling the at least two parallel uplink transmissions. The frequency-domain multiplexing information may be determined based on a time-domain resource allocation comprised in the downlink control information. DCI, scheduling the at least two parallel uplink transmissions. In an example, the frequency-domain multiplexing information is determined based on a frequency-domain resource allocation comprised in the downlink control information. DCI, scheduling the at least two parallel uplink transmissions. In another example, the frequency-domain multiplexing information is determined based on an association with a physical uplink control channel. PUCCH, resource, resource set or format to be used for the at least two parallel uplink transmissions. More specifically, the frequency-domain multiplexing information may be determined based on a physical uplink control channel. PUCCH, resource indicator. PRI, to be used for the at least two parallel uplink transmissions. The frequency-domain multiplexing information may also be determined based on an association with an entry in a time-domain resource allocation. TDRA, table to be used for the at least two parallel uplink transmissions.

The above examples advantageously allow for efficiently indicating the frequency gap or offset. More specifically, for PUCCH, a PUCCH resource (or PUCCH format or set/group of PUCCH resources) may be associated (e.g. via RRC) to a certain frequency-domain gap or offset. Hence, when the UE determines or is indicated to use this PUCCH resource (e.g. through PRI), the UE would be configured to identify the frequency gap or offset that is associated to the applicable multi-TRP PUCCH scheme (such as multi-TRP FDM scheme). Alternatively, an explicit (new or existing) field in the DCI (such as DL DCI) may carry the frequency-domain multiplexing information.

For PUSCH, a TDRA entry or row, in the TDRA table, may be associated (e.g. via RRC) to a frequency-domain gap or offset. Hence, when indicated this entry, the UE would be configured to identify the respective frequency gap or offset associated to the applicable multi-TRP PUSCH scheme (such as multi-TRP FDM scheme).

Alternatively, or additionally, a certain frequency-domain multiplexing information may be associated to or configured or indicated as part of the frequency-domain resource allocation for PUSCH. For instance, the frequency-domain multiplexing information may be added as part of or associated to the RIV (resource indication value) indicated via DCI for frequency allocation type 1. Alternatively, an explicit field in the DCI may carry the frequency-domain multiplexing information (a new or existing (UL) DCI field could be used to this end).

Accordingly, in an embodiment, the base station may comprise means for transmitting, as part of downlink control information. DCI, scheduling the at least two parallel uplink transmissions, the frequency-domain multiplexing information indicative of the frequency gap or the frequency offset between the first frequency-domain resource allocation and the second frequency-domain resource allocation (be it explicitly or implicitly as described above).

In an example, the frequency gap or the frequency offset is defined as an absolute value, in particular as a number of physical resource blocks. PRBs. In another example, the frequency gap or the frequency offset is defined as a relative value, in particular as a ratio or percentage relative to the common frequency-domain resource allocation, or to the first frequency-domain resource allocation, or to the second frequency-domain resource allocation. The frequency gap or the frequency offset may be defined at least in part with respect to a bound (or edge) of the first frequency-domain resource allocation and a bound (or edge) of the second frequency-domain resource allocation. For example, the frequency gap or the frequency offset may be defined between a lower, respectively upper, bound (or edge) of the first frequency-domain resource allocation and a lower, respectively upper, bound (or edge) of the second frequency-domain resource allocation. The frequency gap or the frequency offset may be defined between an upper bound (resp . . . lower bound or edge) of the first frequency-domain resource allocation and a lower bound (resp . . . upper bound or edge) of the second frequency-domain resource allocation. Accordingly, the domain multiplexing information may define the frequency gap or offset as described in the examples above.

The above examples provide advantageous ways for indicating the frequency gap or offset, which will now be described in more detail.

Specifically, a frequency-domain gap (or offset) may in particular be defined for a multi-TRP UL (e.g. PUCCH/PUSCH) scheme. For multi-TRP (e.g. FDM or SDM) UL schemes, the gap (or offset) is defined between the frequency domain resource allocations (or parts) of the two (FDMed or SDMed) UL transmissions towards two TRPs, or equivalently, associated with two UL beams or two power control parameter sets or two SRIs.

The frequency gap or offset, when applied, may be defined between the lower bound (or start) of one frequency domain resource allocation and the lower bound (or start) of the other frequency domain resource allocation corresponding, respectively, to the two (e.g. FDMed or SDMed) UL transmissions/repetitions. Alternatively, the gap may be defined between the upper bound (or end) of one frequency domain resource allocation and the lower bound (or start) of the other frequency domain resource allocation corresponding, respectively, to the two (e.g. FDMed or SDMed) UL transmissions/repetitions.

Alternatively, the frequency gap or offset may be defined as a ratio or percentage or integer multiple of the whole (or part of) the indicated frequency domain allocation (or length or span) of one of the two (e.g. FDMed/SDMed) UL transmissions. Alternatively, the frequency gap or offset may be defined as a ratio or percentage or integer multiple of the entire or common indicated (or configured) frequency domain resource allocation (or length or span) of the two (e.g. FDMed/SDMed) UL transmissions. Still further, the frequency gap or offset may be defined as a number of PRBs between the two frequency-domain resource allocations. As described, the base station (e.g. gNB) may decide that these PRBs are left unused or that they are allocated to another UE(s).

The frequency domain resource allocation of at least one of the UL transmissions may have the same starting RB (or RBG) or same ending RB (or RBG) or same size as the common indicated/configured frequency domain resource allocation(s).

In an example, the at least two parallel uplink transmissions are physical uplink control channel, PUCCH, transmissions. Accordingly, the at least two parallel uplink transmissions may comprise at least one set of uplink control information, UCI. Alternatively, the at least two parallel uplink transmissions may be physical uplink shared channel, PUSCH, transmissions. Accordingly, the at least two parallel uplink transmissions comprise at least one transport block, TB. Details on PUCCH and PUSCH can inter alia be found in the past and current 3GPP technical specifications TS 38.213, TS 38.214, TS 38.331, TS 38.321. The beam information for PUCCH and/or PUSCH may, in an example, be indicated and/or configured based on the 3GPP NR Rel-15/Rel-16 framework or on the Rel-17 unified TCI framework.

In an example, the common frequency-domain resource allocation may be associated with a first and second spatial relation information. The at least two parallel uplink transmissions are transmitted based on different spatial relation information. The at least two parallel uplink transmissions may be transmitted towards different transmission and reception points. TRPs. In other words, the at least two parallel uplink transmissions may be part of a multi-transmission reception point, multi-TPR, uplink scheme. Preferably, the at least two parallel uplink transmissions are transmitted in a frequency division multiplexing. FDM, scheme. Alternatively, the at least two parallel uplink transmissions are transmitted in a spatial division multiplexing. SDM, scheme. As will be explained in more detail further below, there may also be a dynamic switching between the different multiplexing schemes. In an example, the at least two parallel uplink transmissions are transmitted via different (UL) beams. This embodiment may in particular be realized in the frequency range FR2. e.g. 24250 MHZ-52600 MHZ. The at least two parallel uplink transmissions may be transmitted via different power control parameter sets. The at least two parallel uplink transmissions may be transmitted based on different sounding reference signal. SRS, resource indicators, SRIs.

The above scenarios and schemes are particularly advantageous for the described approach of parallel uplink transmission utilizing a frequency gap or offset. Particularly, preferred embodiments may thus be a multi-TRP FDM PUCCH/PUSCH transmission (in particular repetition) scheme or a multi-TRP SDM PUCCH/PUSCH transmission (in particular repetition) scheme.

Under the multi-TRP context, in addition to the TDM (time domain multiplexing) PUCCH/PUSCH transmission (and in particular repetition) operations, the FDM/SDM operations/schemes are particularly relevant for PUCCH and PUSCH operation, as explained above.

For the FDM scheme(s), it is advantageous for the base station (e.g. a gNB) to be able to control and create, when needed, a sort of ‘guard band’ between the two parts of the frequency domain allocation(s) of the transmissions (or parts of a transmission) in order to reduce and in the best case to avoid or minimize interference between the two transmissions. In addition, especially for PUCCH, it is advantageous to provide the base station (e.g. a gNB) with sufficient flexibility in controlling the frequency domain allocation of two transmissions towards different TRPs. Such flexibility allows the base station to enable and benefit from UE multiplexing on the same resources, which increases the resource efficiency of the system: it's worth recalling that PUCCH Formats 0). 1 and 4 allow multiplexing UEs on the same resources.

On the other hand, the SDM scheme(s) may lead to interference between the transmissions towards the different TRPs, but at the same time it allows using same/overlapping time and/or frequency resources thus improving the resource efficiency. Therefore, it advantageous to allow the gNB, depending on the situation, to dynamically choose and switch between FDM and SDM schemes, as will be explained in more detail below.

Said determining of the first frequency-domain resource allocation and the second frequency-domain resource allocation may be further based on frequency-domain partitioning information. The frequency-domain partitioning information may indicate respective amounts of (e.g. the common) frequency-domain resources to be allocated to the first frequency-domain resource allocation and to the second frequency-domain resource allocation. The partitioning information may define the partitioning via absolute or relative (e.g. relative to the common frequency-domain resource allocation) values.

Therein, the frequency-domain partitioning information may be determined based on an association with a physical uplink control channel resource. PUCCH, resource, resource set or format to be used for the at least two parallel uplink transmissions. The frequency-domain partitioning information may be comprised in the received downlink control information. DCI, scheduling the at least two parallel uplink transmissions. The frequency-domain partitioning information may be determined based on an association with an entry in a time-domain resource allocation. TDRA, table to be used for the at least two parallel uplink transmissions. The frequency-domain partitioning information may be indicated at least partially through a resource indication value. RIV. The frequency-domain partitioning information may be indicated at least partially through a bitmap used for the frequency-domain resource allocation. The frequency-domain partitioning may be (pre-) determined or (pre-) configured, for instance defined in the technical specification. e.g. as a constant or static value.

Utilizing partitioning information further improves the flexibility with respect to resource allocations in the discussed scenarios.

More specifically, in addition to the frequency-domain multiplexing information, the partitioning into two parts of the common frequency domain resource allocation between the two UL transmissions may be defined, in particular for a multi-TRP FDM (or even SDM) scheme. To this end, a ratio or percentage, applied on the total configured or indicated frequency domain resource allocation may be configured or indicated to the UE via at least one of e.g. RRC signalling. MAC CE or DCI. In the following, some exemplary variants on how to indicate or define this ratio for partitioning or, more generally, how to indicate or define the partitioning, are as follows:
A PUCCH resource (or PUCCH format or PUCCH resource set/group) may be associated with a partitioning. Accordingly, the partitioning information may in this case be determined based from the PUCCH resource.
A TDRA entry (for PUSCH) nay be associated with a partitioning. Accordingly, the partitioning information may in this case be determined based from the TDRA entry.
The partitioning information may explicitly be indicated in a (new or existing) DCI field.
The partitioning information may at least partially be indicated through the RIV indication or field or through the bitmap indication (used for frequency domain resource allocation indication).
The partitioning may be defined in the specifications. For example, even (or almost even/equal) partitioning may be defined by dividing the total indicated frequency allocation or length by 2 and taking the smallest integer greater than (or lower than) or equal to this fraction as the first resource allocation; the second resource allocation consists of the remaining part or length of the total frequency domain allocation (or size).

As will be explained in more detail below, the UE may be configured to determine or may be indicated (e.g. via a new or existing field in DCI) which one of the two (e.g. FDMed or SDMed) UL transmissions is supposed to be used as the reference transmission. For instance, while one of the partitions (such as the bigger or smaller part) may be used for the reference UL transmission, the other partition is then used for the other UL transmission. Further below, additional alternatives regarding the determination of the reference UL transmission may also be used to determine the reference UL transmission for the partitioning here.

In an example, the at least two parallel uplink transmissions are uplink repetitions associated with the common uplink information payload. Advantageously, the at least two parallel uplink transmissions may be partly or fully overlapping in time, as the frequency multiplexing in particular in combination with the provided frequency gap or offset allows for a partly or complete overlap in the time domain with low or no interference.

In an example, the user equipment may further comprise means for determining one of the at least two uplink transmissions as a reference transmission for determining the frequency-domain resource allocation of the respective other uplink transmission.

For instance, the UE may be configured to determine or may be indicated (e.g. via s new or existing field in the DCI or a MAC CE) which UL transmission of the two (FDMed or SDMed) UL transmissions is used as a reference. The frequency gap or offset may then be used to determine e.g. the lower (or upper) bound of the frequency-domain resource allocation of the other UL transmission considering the reference UL transmission. Exemplary alternatives regarding the determination of reference UL transmission may be as follows.

For example, the UE may be configured to use the UL transmission that is associated with the first TRP (or first indicated UL beam or power control parameters set or SRI) as the reference UL transmission. “First” may be understood e.g. to refer to the first SRI field (in DCI) or to the SRS resource set with lowest (or lower) index or the first spatial relation info (or power control parameters set information) field (in MAC CE).

Alternatively. or additionally, when applicable, the UL transmission corresponding to the lower or higher starting PRB (or resource group block. RBG) index (before applying the gap), of the common frequency domain resource allocation may be considered as the reference UL transmission. The lower or higher PRB (or RBG) index may correspond to the lower or higher frequency of the carrier bandwidth part. BWP. In this case, whether to consider the reference as the one corresponding to the lower or higher starting PRB index may depend on the BWP size and/or which one is closer to (or farther from) the BWP boundary. Note that the UE may apply a shorter gap than configured or indicated. e.g. if the configured or indicated gap would require frequency span greater than the BWP size.

The indicated UL beams or power control parameters sets (or SRIs) or TRPs may be mapped to the two (e.g. FDMed or SDMed) UL transmissions in various ways. For instance, the first indicated SRI (e.g. first SRI field or the SRI corresponding to the SRS resource set with lowest index) may be mapped to the reference UL transmissions, where examples how to determine the reference transmission have been discussed above. Similarly, the first indicated spatial relation info (e.g. first spatial relation information field) may be mapped to the reference UL transmission. Similarly, the first indicated power control parameters set (e.g. first power control info field) may be mapped to the reference UL transmission.

The user equipment may further comprise means for determining a multiplexing scheme (i.e. multi-TRP scheme), in particular a FDM. SDM, or TDM scheme, based on the frequency-domain multiplexing information. The user equipment may also comprise means for switching to a multiplexing scheme (i.e. multi-TRP scheme) associated with the frequency gap or offset defined by the frequency-domain multiplexing information.

Therein, the multiplexing scheme may either be explicitly indicated or the user equipment may first derive the multiplexing scheme associated with the frequency gap or offset defined by the frequency-domain multiplexing information.

The above does not only allow to enable a sufficiently flexible multiplexing scheme from a frequency domain allocation perspective, but also enables a dynamic switch between different (e.g. SDM. FDM and TDM) schemes. More specifically, this has the advantage that, for different service requirements (especially latency budget) for a UE, a dynamic switch in particular between the TDM schemes and the FDM and SDM schemes can be enabled for the base station, as the FDM or SDM schemes would clearly allow reducing the latency compared to the TDM schemes.

In the following exemplary embodiments for indicating the scheme through the frequency-domain gap or offset will be described.

For instance, a frequency-domain gap or offset (e.g. an entry or value of the gap or offset) may be associated (e.g. via RRC) to a multi-TRP PUCCH/PUSCH/SRS scheme. For instance, a specific or dedicated frequency gap or offset entry or value (such as a negative value or specific or dedicated non-negative value) may be associated to a multi-TRP SDM scheme using the common frequency-domain resource allocation for the at least two parallel uplink transmissions. When this frequency gap or offset entry/value is indicated to the UE (and multi-TRP operation applies), the UE may apply the corresponding multi-TRP UL SDM scheme. For instance, a specific or dedicated frequency gap or offset entry or value (such as a negative value or specific non-negative value) may be associated to a multi-TRP TDM scheme. When indicated this entry or value (and multi-TRP operation applies), the UE may apply the multi-TRP UL TDM scheme using the common frequency-domain resource allocation for the at least two parallel uplink transmissions. Then any other value than the one or two specific values would be indicative of a multi-TRP FDM scheme and indicative of a frequency gap or frequency offset to be applied between the first and second frequency-domain resource allocations.

For configured grant (CG) Type 1 PUSCH, the frequency gap or offset may be configured as part of the CG configuration. For CG Type 2 PUSCH, the frequency gap or offset may for instance be indicated via the (re-activation DCI. The UE then follows the activation DCI for all the corresponding PUSCH repetition bundles. In addition, for CG Type 1 PUSCH, the frequency domain allocation partitioning may be configured as part of the CG configuration. For CG Type 2 PUSCH, the frequency domain allocation partitioning may at least partially be indicated via the (re-) activation DCI. The UE then follows the activation DCI for all the corresponding PUSCH repetition bundles. In addition, for CG Type 1 PUSCH, the frequency partitioning between two corresponding parallel PUSCH transmissions/repetitions may be indicated (via RRC) as part of the CG PUSCH configuration. Further, for CG Type 1 PUSCH, the reference PUSCH transmission/repetition, between two corresponding parallel PUSCH transmissions/repetitions, may be indicated (via RRC) as part of the CG PUSCH configuration.

For multi-TRP (FDM or SDM) PUCCH or PUSCH repetition operation, when the PUSCH or PUCCH inter-slot or intra-slot (or sub-slot) frequency hopping is enabled, the frequency hopping pattern may apply for each pair of FDMed or SDMed PUSCH or PUCCH repetitions (i.e. on a pair basis). i.e. each pair of FDMed or SDMed PUSCH or PUCCH repetitions are hopped together after applying the frequency gap or offset to the frequency resource allocation.

While, the described approach is particularly advantageous for the case where the UL transmissions are associated to the same information or payload (e.g. UCI or TB or SRS). However, in a variant, when two UL transmissions overlap at least in time and correspond to different UCI(s), different TB(s) and/or different SRS(s) or SRS resource sets, the base station (e.g. gNB) may indicate to create a frequency gap or offset, or increase an existing offset by an additional frequency gap or offset between the two UL transmissions. Therein, the proposed ways described above for indicating a frequency gap or offset are applicable in this case as well. As an example, at least one of the DCIs or at least one of the UL configurations corresponding to the UL transmissions may be used to indicate the frequency gap or offset.

In a variant to a multi-TRP scheme indication or determination, a PUCCH resource may be directly associated to a multi-TRP PUCCH scheme. Similarly, a TDRA entry may be directly associated to a multi-TRP PUSCH scheme. In another variant, a multi-TRP UL scheme may be indicated via DCI and/or via MAC CE. Specifically, for a signaling via DCI either an explicit field is used or an existing field(s) is reinterpreted to provide the indication or selection of the operation mode. Alternatively, different or dedicated RNTIs or different or dedicated CORESETs may be used as an implicit indication of the multi-TRP UL scheme to use.

In another example, a bitmap (or codepoint and associated entries) may be used to indicate (e.g. via DCI, MAC CE, and/or RRC) the (entire) frequency domain resource allocation for the (e.g. FDMed or SDMed) UL transmissions/repetitions. For instance, at least one bit of this bitmap (or codepoint and associated entries) may be used to indicate one or more of the following: reference UL transmission/repetition, frequency domain gap size (e.g. in number of RBs or RBGs), whether to apply the frequency domain gap or not, which multi-TRP UL scheme to use, mapping of indicated UL beams (or SRIs or power control parameters sets) to the (e.g. FDMed or even SDMed) UL transmissions. Alternatively or additionally, at least one bit (or codepoint and associated entries) may be used to indicate how to partition the frequency domain allocation (e.g. a specific bit pattern or values may indicate at least one frequency domain allocation partition or may indicate the split between the two partitions or indicate how to read the bitmap in such a way to extract the two partitions, etc.).

Generally, the base station (e.g. gNB) may dynamically indicate via (e.g. new or existing fields/bits) DCI or

MAC CE whether to apply one or more of the proposed operations provided above. i.e. applying a frequency gap or offset, applying a specific partitioning (e.g. other than equal or almost equal or even partitioning).

Considering the two frequency domain allocations corresponding to the two (e.g. FDMed or SDMed) UL transmissions, the following two exemplary mapping modes may be considered: A single codeword may be mapped across both frequency domain allocations. Similarly, for PUCCH, a single set of encoded UCI bits may be mapped across the frequency domain allocations. Alternatively, different codewords may be mapped to the different frequency domain allocations, or more generally different codewords may be mapped to each of the two (e.g. FDMed or SDMed) UL transmissions. Similarly, for PUCCH, different sets of the encoded UCI bits may be mapped to each of the two FDMed (or even SDMed) UL transmissions/repetitions.

It should be noted that the application of a frequency-domain gap or offset and/or partitioning (based on the above described approach) may impact which UCI part(s) or TB part(s) is considered for each of the two (e.g. FDMed or SDMed) UL transmissions or it may impact the UCI size and/or TB size to assume for the UL transmissions.

In case intra-slot or intra-subslot frequency hopping is enabled (for instance, be it for SDM or FDM schemes), one or each UL transmission is divided into two UL hops (e.g. PUCCH or PUSCH hops). In this case. e.g. for two FDMed or SDMed UL transmissions, the defined frequency domain gap (when applicable) may be applied between the first hop of the first UL transmission and the first hop of the second UL transmission and/or between the second hop of the first UL transmission and the second hop of the second UL transmission.

It is to be understood that the presentation of the embodiments disclosed herein is merely by way of examples and non-limiting.

Herein, the disclosure of a method step shall also be considered as a disclosure of means for performing the respective method step. Likewise, the disclosure of means for performing a method step shall also be considered as a disclosure of the method step itself.

Other features of the present disclosure will become apparent from the following detailed description considered in conjunction with the accompanying drawings. It is to be understood, however, that the drawings are designed solely for purposes of illustration and not as a definition of the limits of the present disclosure, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic diagram illustrating an example radio environment in which exemplary embodiments of the present disclosure may be performed;

FIG. 2 is a schematic diagram illustrating an exemplary embodiment for a FDM scheme for transmitting PUCCH repetitions:

FIG. 3 is a schematic diagram illustrating an exemplary embodiment for a SDM scheme for transmitting PUCCH repetitions:

FIG. 4 is a schematic diagram illustrating an exemplary embodiment for a FDM scheme for transmitting PUSCH repetitions utilizing partitioning information:

FIG. 5 is a schematic diagram illustrating an exemplary embodiment for a FDM scheme for transmitting PUCCH repetitions with frequency hopping:

FIG. 6 is schematic diagram illustrating a block diagram of an exemplary embodiment of an apparatus according to the present disclosure:

FIG. 7 is a block diagram of an exemplary embodiment of a base station; and

FIG. 8 is a schematic illustration of examples of tangible and non-transitory computer-readable storage media.

The following description serves to deepen the understanding of the present disclosure and shall be understood to complement and be read together with the description of example embodiments of the present disclosure as provided in the above SUMMARY section of this specification.

While the specific radio system in the examples below is 5G, this is only to be considered a non-limiting example.

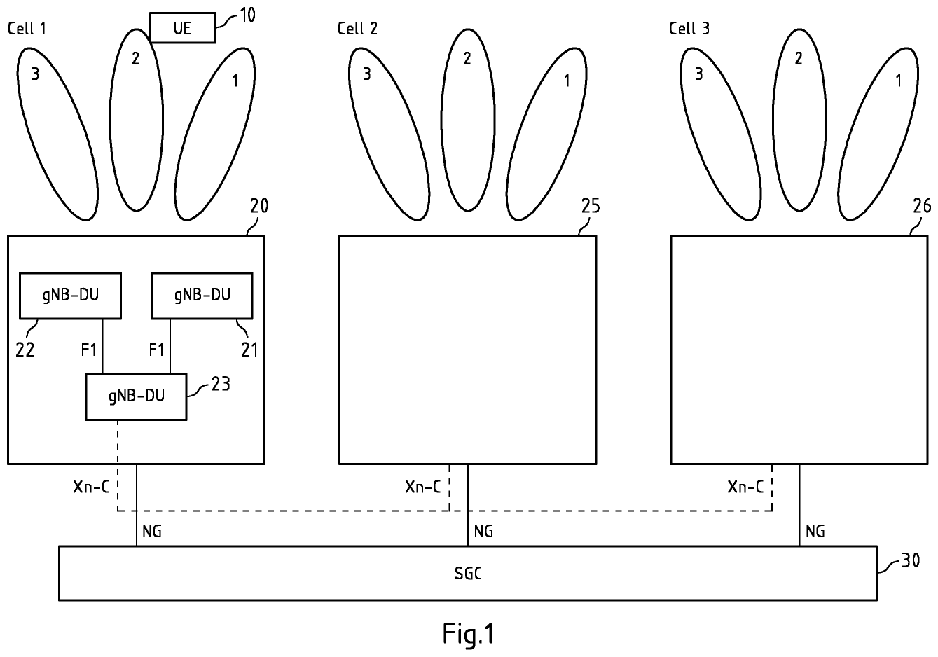

FIG. 1 shows an example environment, in which the present disclosure may be applied. FIG. 1 shows a 5G communication network, which introduces the New Radio technology and also an architecture for which the different sublayers of the RAN may be split into two logical entities in a communication network control element (like a BS or gNB), which are referred to as distributed unit (DU) and central unit (CU). For example, the CU is a logical node that controls the operation of one or more DUs over a front-haul interface (referred to as F1 interface). The DU is a logical node including a subset of the gNB functions, depending on the functional split option.

As shown in FIG. 1, a user equipment (UE) 10, as an example of a user equipment of the first exemplary aspect of the present disclosure, is connected to a cell 1 of a base station, a gNB 20 via a communication beam of the cell 1. In the example shown in FIG. 1, the gNB 20 is provided with a CU 23 and two DUs 21 and 22 being connected to the CU 23 by a F1 interface. Furthermore, as shown in the example of FIG. 1, there is a plurality of further cells to which the UE 10 can connect. Similarly to cell 1, cells 2 and 3 are controlled by gNB 25 and 26, respectively, and each provides a plurality of beams 1 to 3. The different beams of a 5G network may be used for beam diversity or beam hopping.

As shown in FIG. 1, each base station or gNB of the cells is connected to a core network, such as a 5GC, via respective interfaces, indicated as NG interfaces. Furthermore, each gNB of the cells is connected with each other by means of a specific interface, which is referred to e.g. as an Xn-C interface.

Any of these network entities, such as the gNB, gNB-DU, gNB-CU and/or 5GC, may individually or together be an example of a network or network entity according present disclosure.

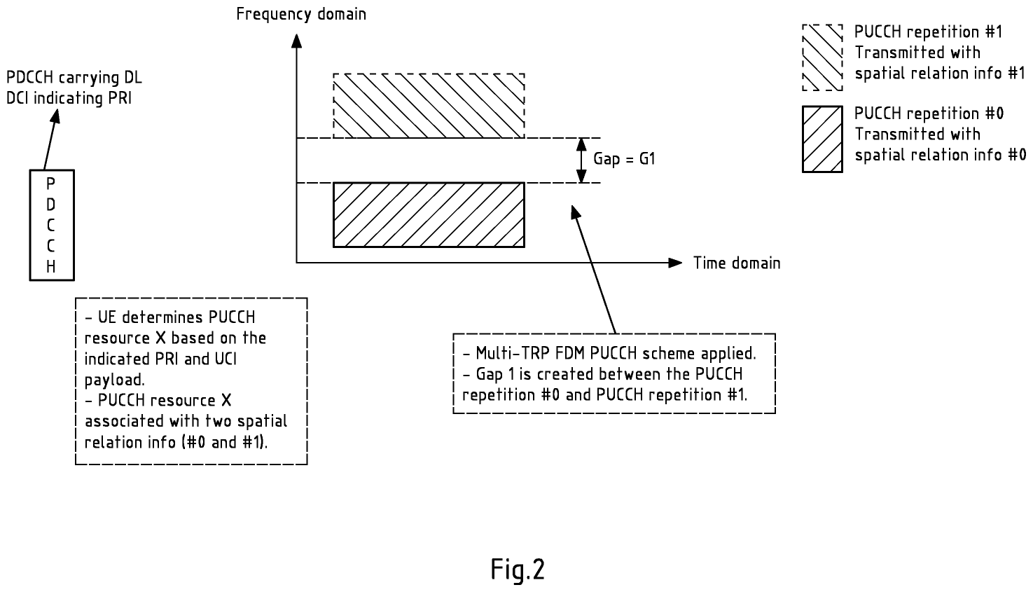

FIG. 2. shows an example illustrating one embodiment (in this case for PUCCH) of the disclosed aspects. In this example, a PUCCH resource X is associated (e.g. via RRC) to a frequency-domain multiplexing information defining a frequency gap or offset value (or size), denoted G1 in FIG. 2. In this example, the frequency gap or offset is defined between the upper bound (or end) of the frequency domain allocation of the reference UL repetition and the lower bound (or start) of the frequency domain allocation of the other UL repetition. In addition, it is defined that this gap value (implicitly) indicates that a multi-TRP PUCCH FDM scheme should be used (when multi-TRP operation is applicable). Also, PUCCH resource X is assumed to be indicated or associated with two spatial relation information, referred to as spatial relation info #0 and #1 in FIG. 2.

After the UE has determined that it should use PUCCH resource X based on the indicated PRI (indicated in DCI) and UCI payload (and supposing that multi-TRP operation is applicable), the UE configures itself to use the multi-TRP PUCCH FDM scheme, where the UCI is repeated on two FDMed PUCCH repetitions (#0) and #1), and the UE creates a frequency-domain gap G1 between PUCCH repetition #0 and PUCCH repetition #1.

In this example, the reference UL repetition is PUCCH repetition #0 e.g. determined as the one corresponding to the first indicated spatial relation information (i.e. spatial relation info #0). The frequency domain resource allocation of PUCCH repetition #0 is given by the frequency domain resource allocation of PUCCH resource X. And the frequency domain resource allocation of PUCCH repetition #1 has the same size as that of PUCCH repetition #0 but with a different starting point (determined based on gap G1 as shown in the figure).

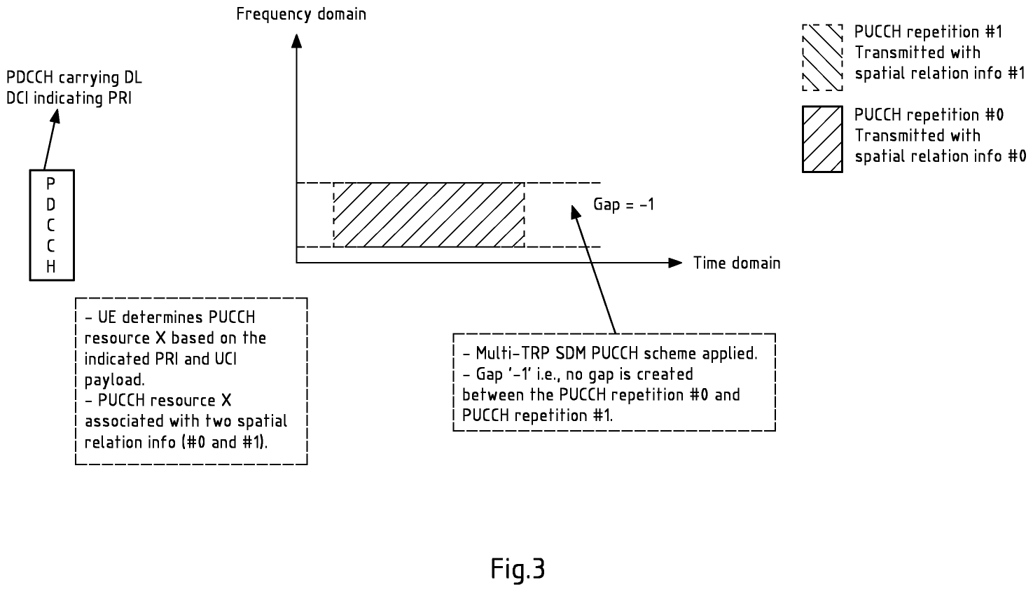

In FIG. 3 a diagram illustrating another example embodiment (for PUCCH) of the disclosed aspects is provided. In this example, a PUCCH resource X is associated (e.g. via RRC) to a frequency-domain gap or offset value (or size) equal to “−1”. In addition, it is defined that this gap value (implicitly) indicates that multi-TRP PUCCH SDM scheme should be used (when multi-TRP operation is applicable). PUCCH resource X is assumed to be indicated or associated with two spatial relation information (referred to as spatial relation info #0 and #1 in FIG. 3).

After the UE has determined that PUCCH resource X should be used based on the indicated PRI (indicated in DCI) and UCI payload (and supposing that multi-TRP operation is applicable), the UE uses the multi-TRP PUCCH SDM scheme, where the UCI is repeated on two SDMed PUCCH repetitions (#0) and #1), for which the UE also knows from the frequency gap or offset value of “−1”, that no gap or more precisely a “negative gap” is supposed to be inserted between the PUCCH repetition #0 and the PUCCH repetition #1, so that the PUCCH repetitions use the same resources in the time frequency domain. In other words, this value is interpreted such that the frequency resource allocation of PUCCH repetition #1 is shifted downwards, so that the frequency resource allocation of PUCCH repetition #1 is identical to frequency resource allocation of PUCCH repetition #0, as illustrated in FIG. 3. Generally, it may also be conceivable that the frequency gap or offset value only indicated a partial overlap between the resource allocations for the two UL transmissions in the frequency domain.

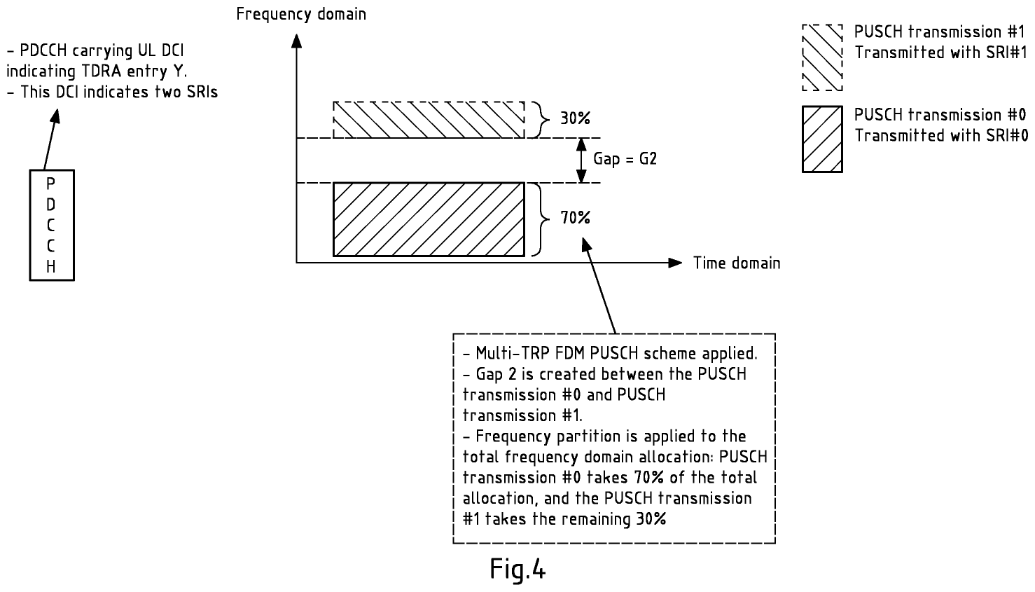

In FIG. 4 a diagram illustrating another example embodiment (for PUSCH) of the disclosed aspects is provided. In this example. TDRA entry Y is associated (e.g. via RRC) to a Gap value=G2. Also, TDRA entry Y is associated to a Ratio R, which as an example equals to 0.7 here. In addition. Gap value G2 is configured to (implicitly) indicate that multi-TRP FDM PUSCH scheme should be used (when multi-TRP operation is applicable). The gap here is defined between the upper bound of the frequency domain resource allocation of the reference UL transmission (PUSCH transmission #0) and the lower bound of the frequency domain resource allocation of the other UL transmission (PUSCH transmission #1).

When TDRA entry Y is now indicated to the UE via DCI (and supposing that multi-TRP operation is applicable), the UE applies the multi-TRP FDM PUSCH scheme, where two PUSCH transmissions (#0 and #1) are FDMed and associated with different SRIs (or UL beams). A frequency gap or offset with gap value G2 is created between the PUSCH transmission #0) and PUSCH transmission #1. Moreover, a frequency partitioning is applied on the total frequency domain allocation: Ratio R=0.7 indicates that PUSCH transmission #0) shall take 70% of the total allocation, and PUSCH transmission #1 shall take the remaining 30%.

On the mapping aspect, either a single codeword is mapped across both frequency domain resource allocations or a codeword is considered for each of the two frequency domain resource allocations/parts (where the codeword for each part may be different).

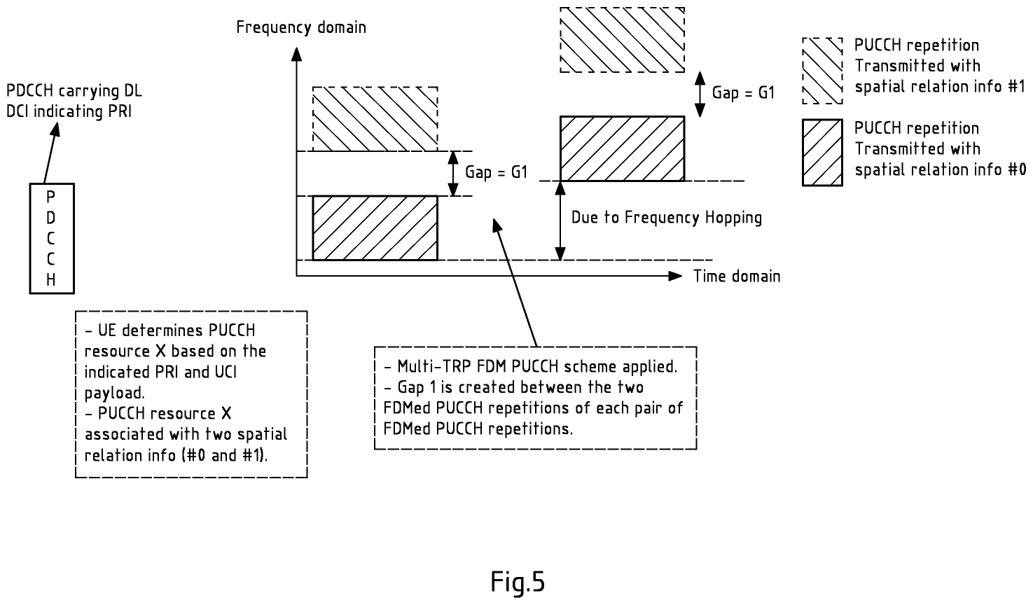

In FIG. 5, an example illustrating one embodiment (for PUCCH) of the proposed solutions is provided. This example is similar to the example of FIG. 4, and the key difference is that in FIG. 5 there are two pairs of FDMed PUCCH repetitions wherein these pairs are in different slots or sub-slots (or more generally at different times) and where frequency hopping (e.g. inter-slot or inter-subslot frequency hopping) is enabled between the pairs of FDMed repetitions. As shown in FIG. 5, gap G1 is applied between the two FDMed PUCCH repetitions of each pair of FDMed repetitions.

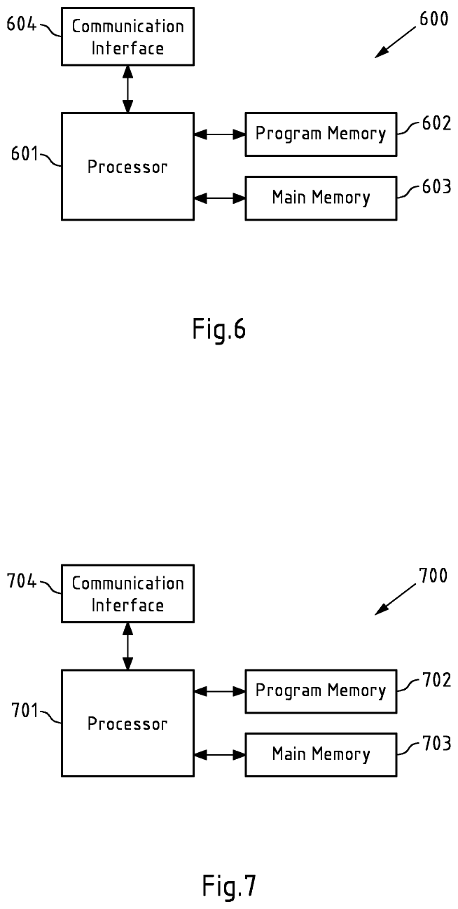

Turning now to FIG. 6, there is shown a block diagram of an exemplary embodiment of a UE 600 according to the present disclosure, such as UE 10 of FIG. 1. For example, UE 600 may be one of a smartphone, a tablet computer, a notebook computer, a smart watch, a smart band, an IoT device or a vehicle or a part thereof.

UE 600 comprises a processor 601. Processor 601 may represent a single processor or two or more processors, which are for instance at least partially coupled, for instance via a bus. Processor 601 executes a program code stored in program memory 602 (for instance program code causing mobile device 600 in connection with network entity 700 to perform one or more of the embodiments of a method according to the present disclosure or parts thereof, when executed on processor 601), and interfaces with a main memory 603. Program memory 602 may also contain an operating system for processor 601. Some or all of memories 602 and 603 may also be included into processor 601.

One of or both of a main memory and a program memory of a processor (e.g. program memory 602 and main memory 603) could be fixedly connected to the processor (e.g. processor 601) or at least partially removable from the processor, for instance in the form of a memory card or stick.

A program memory (e.g. program memory 602) may for instance be a non-volatile memory. It may for instance be a FLASH memory (or a part thereof), any of a ROM. PROM. EPROM. MRAM or a FeRAM (or a part thereof) or a hard disc (or a part thereof), to name but a few examples. For example, a program memory may for instance comprise a first memory section that is fixedly installed, and a second memory section that is removable from, for instance in the form of a removable SD memory card.

A main memory (e.g. main memory 603) may for instance be a volatile memory. It may for instance be a DRAM memory, to give non-limiting example. It may for instance be used as a working memory for processor 601 when executing an operating system, an application, a program, and/or the like.

Processor 601 further controls a communication interface 604 (e.g. radio interface) configured to receive and/or transmit data and/or information. For instance, communication interface 604 may be configured to transmit and/or receive radio signals from a radio node, such as a base station. It is to be understood that any computer program code based processing required for receiving and/or evaluating radio signals may be stored in an own memory of communication interface 604 and executed by an own processor of communication interface 604 and/or it may be stored for example in memory 603 and executed for example by processor 601.

Communication interface 604 may in particular be configured to communicate according to a cellular communication system like a 2G/3G/4G/5G or future generation cellular communication system. Mobile device 600 may use radio interface 604 to communicate with a base station. e.g. base station 20 depicted in FIG. 1.

For example, the communication interface 604 may further comprise a BLE and/or Bluetooth radio interface including a BLE transmitter, receiver or transceiver. For example, radio interface 604 may additionally or alternatively comprise a WLAN radio interface including at least a WLAN transmitter, receiver or transceiver.

The components 602 to 604 of mobile device 600 may for instance be connected with processor 601 by means of one or more serial and/or parallel busses.

It is to be understood that mobile device 600 may comprise various other components. For example, mobile device 600 may optionally comprise a user interface (e.g. a touch-sensitive display, a keyboard, a touchpad, a display, etc.).

FIG. 7 is a block diagram of an exemplary embodiment of a network entity, such as base station or gNB 20 and/or core network 30 (or a part thereof) of FIG. 1. For instance, network entity 700 may be configured for scheduling and/or transmitting signals, such as information indicative of a common frequency-domain resource allocation, to the UE, as described above.

Apparatus 700 comprises a processor 701. Processor 701 may represent a single processor or two or more processors, which are for instance at least partially coupled, for instance via a bus. Processor 701 executes a program code stored in program memory 702 (for instance program code causing apparatus 700 to perform alone or together with mobile device 600 embodiments according to the present disclosure or parts thereof), and interfaces with a main memory 703.

Program memory 702 may also comprise an operating system for processor 701. Some or all of memories 702 and 703 may also be included into processor 701.

Moreover, processor 701 controls a communication interface 704 which is for example configured to communicate according to a cellular communication system like a 2G/3G/4G/5G cellular communication system. Communication interface 704 of apparatus 700 may be realized by radio heads 30 for instance and may be provided for communication between base station 20 and UE 10 in FIG. 1.

The components 702 to 704 of apparatus 700 may for instance be connected with processor 701 by means of one or more serial and/or parallel busses.

Mobile device 600 together with communication interface 604 may in particular be configured for receiving signals from a network entity 700 and transmitting signals to network entity 700, such as one or both of the at least two uplink transmission, according to the approach scheme describe herein.

It is to be understood that apparatuses 600, 700 may comprise various other components.

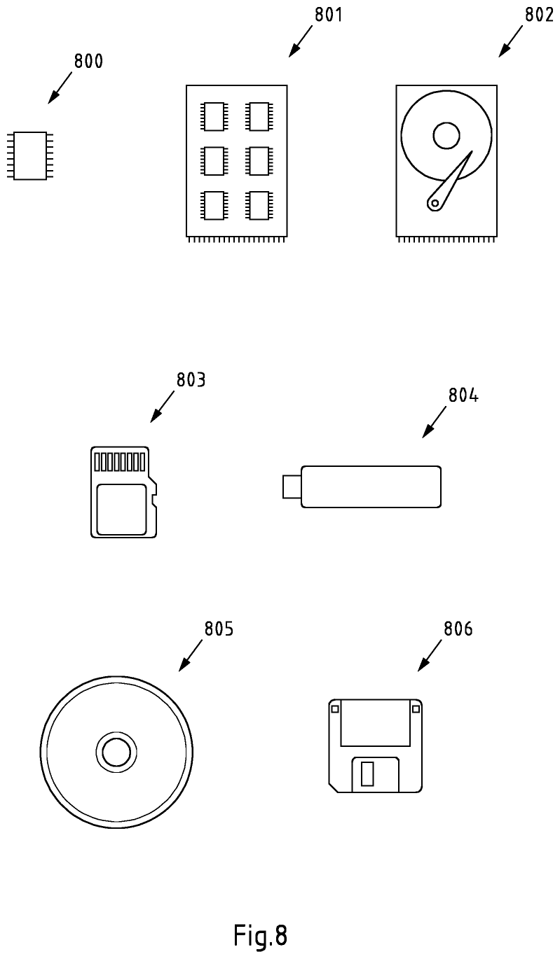

FIG. 8 is a schematic illustration of examples of tangible and non-transitory computer-readable storage media according to the present disclosure that may for instance be used to implement memory 602 of FIG. 6 or memory 702 of FIG. 7. To this end. FIG. 8 displays a flash memory 800, which may for instance be soldered or bonded to a printed circuit board, a solid-state drive 801 comprising a plurality of memory chips (e.g. Flash memory chips), a magnetic hard drive 802, a Secure Digital (SD) card 803, a Universal Serial Bus (USB) memory stick 804, an optical storage medium 805 (such as for instance a CD-ROM or DVD) and a magnetic storage medium 806.

The advantages of the proposed solution are in particular as follows:
provide sufficient flexibility in the frequency domain allocation when considering multi-TRP FDMed and SDMed UL transmission/repetition operations. At least for PUCCH, this allows increasing the UE multiplexing capacity.
allow to combat inter-carrier interference when such is needed.
dynamically choose and switch between multi-TRP FDM and SDM schemes.

Any presented connection in the described embodiments is to be understood in a way that the involved components are operationally coupled. Thus, the connections can be direct or indirect with any number or combination of intervening elements, and there may be merely a functional relationship between the components.

Further, as used in this text, the term ‘circuitry’ refers to any of the following:
(a) hardware-only circuit implementations (such as implementations in only analog and/or digital circuitry)
(b) combinations of circuits and software (and/or firmware), such as: (i) to a combination of processor(s) or
   (ii) to sections of processor(s)/software (including digital signal processor(s)), software, and memory(ies) that work together to cause an apparatus, such as a mobile phone, to perform various functions) and
(c) to circuits, such as a microprocessor(s) or a section of a microprocessor(s), that re-quire software or firmware for operation, even if the software or firmware is not physically present.

This definition of ‘circuitry’ applies to all uses of this term in this text, including in any claims. As a further example, as used in this text, the term ‘circuitry’ also covers an implementation of merely a processor (or multiple processors) or section of a processor and its (or their) accompanying software and/or firmware. The term ‘circuitry’ also covers, for example, a baseband integrated circuit or applications processor integrated circuit for a mobile phone.

Any of the processors mentioned in this text, in particular but not limited to processors 601 and 701 of FIGS. 6 and 7, could be a processor of any suitable type. Any processor may comprise but is not limited to one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s). The relevant structure/hardware has been programmed in such a way to carry out the described function.

Moreover, any of the actions or steps described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICs, signal processing devices, and other devices.

Moreover, any of the actions described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICs, signal processing devices, and other devices.

The wording “A, or B, or C, or a combination thereof” or “at least one of A, B and C” may be understood to be not exhaustive and to include at least the following: (i) A, or (ii) B, or (iii) C, or (iv) A and B, or (v) A and C, or (vi) B and C, or (vii) A and B and C.

It will be understood that the embodiments disclosed herein are only exemplary, and that any feature presented for a particular exemplary embodiment may be used with any aspect of the present disclosure on its own or in combination with any feature presented for the same or another particular exemplary embodiment and/or in combination with any other feature not mentioned. It will further be understood that any feature presented for an example embodiment in a particular category may also be used in a corresponding manner in an example embodiment of any other category.

### List of Abbreviations

5G—5th Generation
gNB—5G/NR base station
NR—New Radio
RAN—Radio Access Network
UE—User Equipment
TRP—Transmission Reception Point
UL—Uplink
DL—Downlink
DCI—Downlink Control Information
MAC CE—Medium Access Control Control Element
PUCCH—Physical Uplink Control Channel
PUSCH—Physical Uplink Shared Channel
PDCCH—Physical Downlink Control Channel
PDSCH—Physical Downlink Shared Channel
PRI—PUCCH Resource Index
TCI-Transmission Configuration Indicator
TDM—Time Division Multiplexing
UCI—Uplink Control Information
FR 1—Frequency Range 1
SR—Scheduling Request
CSI—Channel State Information
HARQ—Hybrid Automatic Repeat request
HARQ-ACK—HARQ Acknowledgment
CCE—Control Channel Element
CORESET—Control Resource Set
SRI—SRS resource indicator
SSB—Synchronization Signal Block
RS—Reference Signal
RNTI—Radio-Network Temporary Identifier
C-RNTI—Cell Radio-Network Temporary Identifier
MPE—Maximum Permissible Exposure

1-20. (canceled)

21. An apparatus comprising at least one processor and at least one memory including computer program code, the at least one memory and the computer program code configured to, with the at least one processor, cause the apparatus at least to:
transmit at least two parallel uplink transmissions associated with a common uplink information payload and including a first uplink transmission and a second uplink transmission;
receive information indicative of a common frequency-domain resource allocation for the at least two parallel uplink transmissions;
determine, a first frequency-domain resource allocation for the first uplink transmission and a second frequency-domain resource allocation for the second uplink transmission at least based on the common frequency-domain resource allocation and on frequency-domain multiplexing information indicative of a frequency gap or a frequency offset between the first frequency-domain resource allocation and the second frequency-domain resource allocation; and
transmit the first uplink transmission using the first frequency-domain resource allocation, and transmit the second uplink transmission using the second frequency-domain resource allocation.

22. The apparatus of claim 21, wherein the frequency-domain multiplexing information is determined based on received downlink control information (DCI) scheduling the at least two parallel uplink transmissions.

23. The apparatus of claim 22, wherein:
the frequency-domain multiplexing information is comprised in the DCI scheduling the at least two parallel uplink transmissions; or
the frequency-domain multiplexing information is determined based on a time-domain resource allocation comprised in the DCI scheduling the at least two parallel uplink transmissions; or
the frequency-domain multiplexing information is determined based on a frequency-domain resource allocation comprised in the DCI scheduling the at least two parallel uplink transmissions; or
the frequency-domain multiplexing information is determined based on an association with a physical uplink control channel (PUCCH) resource, resource set or format to be used for the at least two parallel uplink transmissions; or
the frequency-domain multiplexing information is determined based on a PUCCH resource indicator to be used for the at least two parallel uplink transmissions; or
the frequency-domain multiplexing information is determined based on an association with an entry in a time-domain resource allocation (TDRA) table to be used for the at least two parallel uplink transmissions.

24. The apparatus of claim 21, wherein the frequency gap or the frequency offset is defined as an absolute value, in particular as a number of physical resource blocks.

25. The apparatus of claim 21, wherein the frequency gap or the frequency offset is defined as a relative value, in particular as a ratio or percentage and in particular relative to the common frequency-domain resource allocation, or to the first frequency-domain resource allocation, or to the second frequency-domain resource allocation.

26. The apparatus of claim 21, wherein the frequency gap or the frequency offset is defined at least in part with respect to a bound of the first frequency-domain resource allocation and a bound of the second frequency-domain resource allocation.

27. The apparatus of claim 26, wherein:
the frequency gap or the frequency offset is defined between a lower, respectively upper, bound of the first frequency-domain resource allocation and a lower, respectively upper, bound of the second frequency-domain resource allocation; or
the frequency gap or the frequency offset is defined between an upper bound of the first frequency-domain resource allocation and a lower bound of the second frequency-domain resource allocation.

28. The apparatus of claim 21, wherein the at least two parallel uplink transmissions are PUCCH transmissions, and wherein the common uplink information payload comprises at least one set of uplink control information.

29. The apparatus of claim 21, wherein the at least two parallel uplink transmissions are physical uplink shared channel transmissions, and wherein the common uplink information payload comprises at least one transport block.

30. The apparatus of claim 21, wherein:
the common frequency-domain resource allocation is associated with a first and second spatial relation information; or
the at least two parallel uplink transmissions are transmitted based on different spatial relation information; or
the at least two parallel uplink transmissions are transmitted towards different transmission and reception points (TRP); or
the at least two parallel uplink transmissions are part of a multi-TRP uplink scheme; or
the at least two parallel uplink transmissions are transmitted in a frequency division multiplexing (FDM) scheme; or
the at least two parallel uplink transmissions are transmitted in a spatial division multiplexing (SDM) scheme; or
the at least two parallel uplink transmissions are transmitted via different beams; or
the at least two parallel uplink transmissions are transmitted via different power control parameter sets; or
the at least two parallel uplink transmissions are transmitted based on different sounding reference signal resource indicators.

31. The apparatus of claim 21, wherein said determining of the first frequency-domain resource allocation and the second frequency-domain resource allocation is further based on frequency-domain partitioning information, wherein the frequency-domain partitioning information indicates respective amounts of frequency-domain resources to be allocated to the first frequency-domain resource allocation and to the second frequency-domain resource allocation.

32. The apparatus of claim 31, wherein:
the frequency-domain partitioning information is determined based on an association with a PUCCH resource, resource set or format to be used for the at least two parallel uplink transmissions; or
the frequency-domain partitioning information is comprised in the DCI scheduling the at least two parallel uplink transmissions; or
the frequency-domain partitioning information is determined based on an association with an entry in a TDRA table to be used for the at least two parallel uplink transmissions; or
the frequency-domain partitioning information is indicated at least partially through a resource indication value; or
the frequency-domain partitioning information is indicated at least partially through a bitmap used for the frequency-domain resource allocation; or
the frequency-domain partitioning is predetermined or configured.

33. The apparatus of claim 21, wherein:
the at least two parallel uplink transmissions are uplink repetitions associated with the common uplink information payload; or
the at least two parallel uplink transmissions are partly or fully overlapping in time.

34. The apparatus of claim 21, wherein the apparatus is further caused to:
determine one of the at least two uplink transmissions as a reference transmission for determining the frequency-domain resource allocation of the respective other uplink transmission.

35. The apparatus of claim 21, wherein the apparatus is further caused to:
determine a multiplexing scheme, in particular a FDM, SDM, or time division Multiplexing (TDM) scheme, based on the frequency-domain multiplexing information.

36. An apparatus comprising at least one processor and at least one memory including computer program code, the at least one memory and the computer program code configured to, with the at least one processor, cause the apparatus at least to:
receive at least two parallel uplink transmissions associated with a common uplink information payload and including a first uplink transmission and a second uplink transmission;
transmit information indicative of a common frequency-domain resource allocation for the at least two parallel uplink transmissions; and
receive the first uplink transmission using a first frequency-domain resource allocation, and receiving the second uplink transmission using a second frequency-domain resource allocation, the first frequency-domain resource allocation for the first uplink transmission and the second frequency-domain resource allocation for the second uplink transmission having been determined at least based on the common frequency-domain resource allocation and on frequency-domain multiplexing information indicative of a frequency gap or a frequency offset between the first frequency-domain resource allocation and the second frequency-domain resource allocation.

37. The apparatus of claim 36, wherein the apparatus is further caused to:
transmit, as part of downlink control information (DCI) scheduling the at least two parallel uplink transmissions, the frequency-domain multiplexing information indicative of the frequency gap or the frequency offset between the first frequency-domain resource allocation and the second frequency-domain resource allocation.

38. A method for enabling at least two parallel uplink transmissions associated with a common uplink information payload and including a first uplink transmission and a second uplink transmission, the method comprising, by a user equipment:
receiving information indicative of a common frequency-domain resource allocation for the at least two parallel uplink transmissions;
determining a first frequency-domain resource allocation for the first uplink transmission and a second frequency-domain resource allocation for the second uplink transmission at least based on the common frequency-domain resource allocation and frequency-domain multiplexing information indicative of a frequency gap or a frequency offset between the first frequency-domain resource allocation and the second frequency-domain resource allocation; and
transmitting the first uplink transmission using the first frequency-domain resource allocation, and transmitting the second uplink transmission using the second frequency-domain resource allocation.

39. The method of claim 38, wherein the frequency-domain multiplexing information is determined based on received downlink control information (DCI) scheduling the at least two parallel uplink transmissions.

40. The method of claim 39, wherein:
the frequency-domain multiplexing information is comprised in the DCI scheduling the at least two parallel uplink transmissions; or
the frequency-domain multiplexing information is determined based on a time-domain resource allocation comprised in the DCI scheduling the at least two parallel uplink transmissions; or
the frequency-domain multiplexing information is determined based on a frequency-domain resource allocation comprised in the DCI scheduling the at least two parallel uplink transmissions; or
the frequency-domain multiplexing information is determined based on an association with a physical uplink control channel (PUCCH) resource, resource set or format to be used for the at least two parallel uplink transmissions; or
the frequency-domain multiplexing information is determined based on a PUCCH resource indicator to be used for the at least two parallel uplink transmissions; or
the frequency-domain multiplexing information is determined based on an association with an entry in a time-domain resource allocation (TDRA) table to be used for the at least two parallel uplink transmissions.
